(19) United States
(12) Patent Application Publication
(10) Pub. No.: US 2009/0249081 A1
(43) Pub. Date: Oct. 1, 2009

(54) STORAGE DEVICE ENCRYPTION AND METHOD

(75) Inventor: Fernando A. Zayas, Loveland, CO (US)

Correspondence Address: SCHWEGMAN, LUNDBERG & WOESSNER/TOSHIBA, P.O. BOX 2938, MINNEAPOLIS, MN, 55402, US

(73) Assignee: Kabushiki Kaisha Toshiba-1 Shibaura 1-ChomoMinatoku, tokyo (JP)

(21) Appl. No.: 12/060,182

(22) Filed: Mar. 31, 2008

(51) Int. Cl. H04L 9/14

(52) U.S. Cl. 713/193

(57) ABSTRACT

A hard disk drive, and methods of providing secure access to data on a hard disk drive, are shown. In one example, an access code is sent to a hard disk drive to decipher an encrypted user key stored on the hard disk drive. In one example, at least a portion of the access code is not stored anywhere within the hard disk drive, and is provided from a host.

### BACKGROUND

One example of an information storage device includes a disk drive. Other examples of storage devices include optical storage, solid state storage, other magnetic media storage, or a combination such as a flash memory/hard disk drive. Using the disk drive as a common example, a disk drive includes one or more disks clamped to a rotating spindle and at least one head for reading information representing data from and/or writing data to the surfaces of each disk. The head is supported by a suspension coupled to an actuator that may be driven by a voice coil motor. Control electronics in the disk drive provide electrical signals to the voice coil motor to move the head to desired positions on the disks to read and write the data in tracks on the disks.

It is desirable to have data on a hard drive accessible to rightful owners of the data, yet secure from unwanted access. Increasingly sophisticated methods and devices for encryption and access to data are needed to combat increasingly sophisticated methods being used to defeat existing encryption and access devices and methods.

### BRIEF DESCRIPTION OF THE DRAWINGS

FIG. 1 is a perspective view of a magnetic recording and reproducing apparatus (hard disk drive) according to an example embodiment;

FIG. 2 is a block diagram of a hard disk drive according to an example embodiment;

FIG. 3 is a flow chart of a method of providing secure access to a hard disk drive according to an example embodiment;

FIG. 4 is a schematic flow diagram of a method of providing secure access to a hard disk drive according to an example embodiment; and

FIG. 5 is an example block diagram of a computer system for implementing methods and devices as described in accordance with example embodiments.

### DETAILED DESCRIPTION

Hereinafter, example embodiments of the present invention will be described with reference to the drawings.

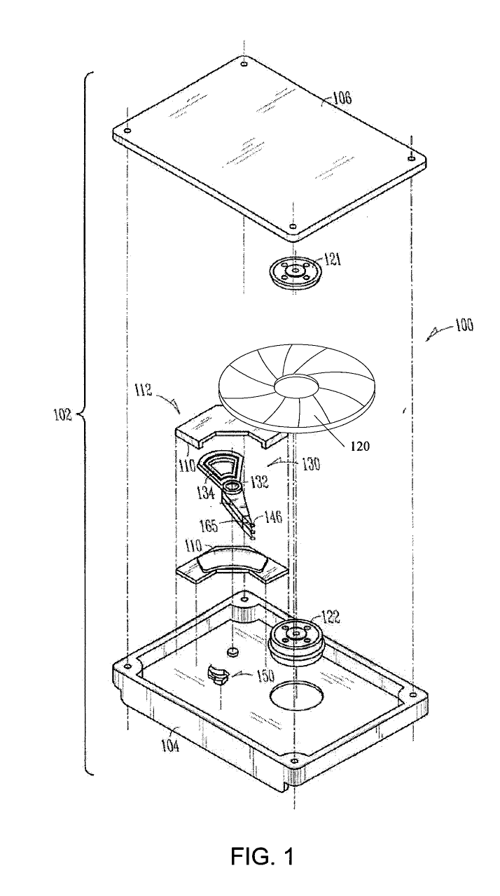

FIG. 1 is an exploded view of disk drive 100 that uses various embodiments of the present invention. A housing 102 is shown that includes a housing base 104 and a housing cover 106. The housing base 104 illustrated is a base casting, but in other embodiments a housing base 104 can comprise separate components assembled prior to, or during assembly of the disk drive 100. The disk 120 is attached to the hub or spindle 122 that is rotated by a spindle motor. The disk 120 can be attached to the hub or spindle 122 by a clamp 121. The disk may be rotated at a constant or varying rate ranging from less than 3,600 to more than 15,000 revolutions per minute. Higher rotational speeds are contemplated in the future. The spindle motor is connected with the housing base 104. The disk 120 can be made of a light aluminum alloy, ceramic/glass or other suitable substrate, with magnetizable material deposited on one or both sides of the disk. The magnetic layer includes small domains of magnetization for storing data transferred through a transducing head 146. The transducing head 146 includes a magnetic transducer adapted to read data from and write data to the disk 120. In other embodiments, the transducing head 146 includes separate read elements and write elements. For example, the separate read element can be a magneto-resistive head, also known as an MR head. It will be understood that multiple head 146 configurations can be used. The transducing head 146 is associated with a slider 165.

A rotary actuator 130 is pivotally mounted to the housing base 104 by a bearing 132 and sweeps an arc between an inner diameter (ID) of the disk 120 and a ramp 150 positioned near an outer diameter (OD) of the disk 120. Attached to the housing 104 are upper and lower magnet return plates 110 and at least one magnet that together form the stationary portion of a voice coil motor (VCM) 112. A voice coil 134 is mounted to the rotary actuator 130 and positioned in an air gap of the VCM 112. The rotary actuator 130 pivots about the bearing 132. It is accelerated in one direction when current of a given polarity is passed through the voice coil 134 and is accelerated in an opposite direction when the given polarity is reversed, allowing for control of the position of the actuator 130 and the attached transducing head 146 with respect to the disk 120. The VCM 112 is coupled with a servo system that uses positioning data read by the transducing head 146 from the disk 120 to determine the position of the transducing head 146 over one of a plurality of tracks on the disk 120. The servo system determines an appropriate current to drive through the voice coil 134, and drives the current through the voice coil 134 using a current driver and associated circuitry. The servo system can also be used to determine excessive accelerations in axes which are parallel to the surface of the disk 120.

One type of servo system is an embedded servo system in which tracks on each disk surface used to store information representing data contain small segments of servo information. It should be noted that in actuality there may be many more servo wedges than as shown in FIG. 1. Although a single disk 120 is shown for ease of illustration, a drive 100 may include two or more disks 120.

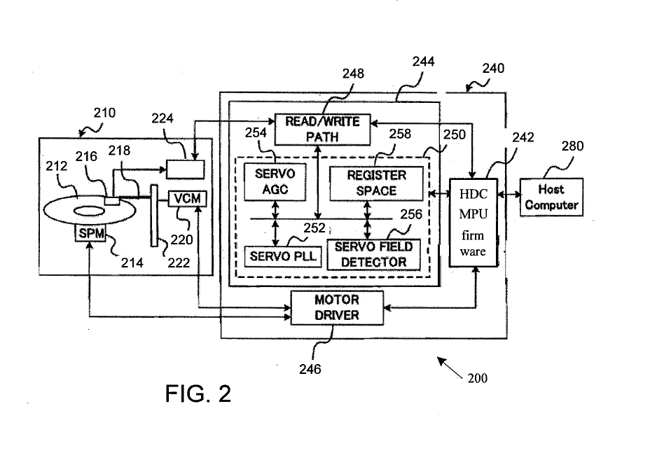

FIG. 2 shows a block diagram of a disk drive 200 similar to the drive shown in FIG. 1, containing machine readable instructions used to provide secure access to data according to an embodiment of the invention. Although an example is shown, one of ordinary skill in the art, having the benefit of the present disclosure, will recognize that other device and circuit configurations than those shown in FIG. 2 are possible, and within the scope of the present invention. FIG. 2 shows a head slider 216 similar to head 146 from FIG. 1, only above the top surface of a magnetic disk 212 similar to the disk 120 from FIG. 1. In other examples, the magnetic recording layer is formed on each side of the magnetic disk. A down head and an up head may be provided above the bottom and top surfaces of the magnetic disk, respectively. The disk drive includes a main body unit called a head disk assembly (HDA) 210 and a printed circuit board (PCB) 240.

As shown in FIG. 2, the HDA 210 has the magnetic disk 212, a spindle motor 214, which rotates the magnetic disk 212, a head slider 216, including a read head and a write head, a suspension/actuator arm 218, a VCM 220, and a head amplifier, which is not shown. The head slider 216 is provided with a read head including a read element, such as a giant magnetoresistive (GMR) element and a write head.

The head slider 216 may be elastically supported by a gimbal provided on the suspension/actuator arm 218. The suspension/actuator arm 218 is rotatably attached to a pivot 222. The VCM 220 generates a torque around the pivot 222 for the suspension/actuator arm 218 to move the head in an arc across the magnetic disk 212. A connector 224 is shown to couple between the suspension/actuator arm 128 and the PCB 240. A number of connector configurations are possible. In one connector 224 example a flexible cable connects to a small printed circuit board assembly with a preamplifier. The small printed circuit board assembly includes a connector that protrudes through a HDA 210 and plugs into PCB 240.

As described above, the magnetic recording layer is formed on each side of the magnetic disk 212, and servo zones, each shaped like an arc, are formed so as to correspond to the locus of the moving head. In one example the radius of an arc formed by a servo zone is given as the distance from the pivot to the read/write portion of the head slider 216.

In one example, several major electronic components are mounted on the PCB 240. The components include a controller 242, a read/write channel IC 244, and a motor driver IC 246. Although the controller 242 and other components such as the read/write channel IC 244 are shown as separate components, other embodiments integrate one or more components to form a system on a chip (SOC). One of ordinary skill in the art will recognize that a number of configurations of integrated or separate components are within the scope of the invention.

The controller 242 in one example includes a disk controller (HDC) and an MPU, and firmware. The MPU is a control unit of a drive system and includes ROM, RAM, CPU, and a logic processing unit that implements a head positioning control system according to the present example embodiment. The logic processing unit is an arithmetic processing unit comprised of a hardware circuit to execute high-speed calculations. Firmware for the logic processing circuit is saved to the ROM or elsewhere in the disk drive. The MPU controls the drive in accordance with firmware.

The disk controller 242 is an interface unit in the hard disk drive which manages the whole drive by exchanging information with interfaces between the disk drive and a host 280 (for example, a personal computer, portable music player, etc.) and with the MPU, read/write channel IC 244, and motor driver IC 246. In one example, machine readable instructions are executed within the disk controller 242 to provide secure access to data according to embodiments of the invention.

The read/write channel IC 244 is a head signal processing unit relating to read/write operations. The read/write channel IC 244 is shown as including a read/write path 248 and a servo demodulator 250. The read/write path 248, which can be used to read and write user data and servo data, may include front end circuitry useful for servo demodulation. The read/write path 248 may also be used for self-servo writing. It should be noted that the disk drive also includes other components, which are not shown because they are not necessary to explain the example embodiments.

The servo demodulator 250 is shown as including a servo phase locked loop (PLL) 252, a servo automatic gain control (AGC) 254, a servo field detector 256 and register space 258. The servo PLL 252, in general, is a control loop that is used to provide frequency and phase control for the one or more timing or clock circuits (not shown in FIG. 2) within the servo demodulator 250. For example, the servo PLL 252 can provide timing signals to the read/write path 248. The servo AGC 254, which includes (or drives) a variable gain amplifier, is used to keep the output of the read/write path 248 at a substantially constant level when servo zones on one of the disks 212 are being read. The servo field detector 256 is used to detect and/or demodulate the various subfields of the servo zones, including a SAM (Servo Address Mark), a track number, a first servo burst, a second servo burst, additional servo bursts, and other possible information. The MPU is used to perform various servo demodulation functions (e.g., decisions, comparisons, characterization and the like) and can be thought of as being part of the servo demodulator 250. In the alternative, the servo demodulator 250 can have its own microprocessor.

One or more registers (e.g., in register space 258) can be used to store appropriate servo AGC values (e.g., gain values, filter coefficients, filter accumulation paths, etc.) for when the read/write path 248 is reading servo data, and one or more registers can be used to store appropriate values (e.g., gain values, filter coefficients, filter accumulation paths, etc.) for when the read/write path 248 is reading user data. A control signal can be used to select the appropriate registers according to the current mode of the read/write path 248. The servo AGC value(s) that are stored can be dynamically updated. For example, the stored servo AGC value(s) for use when the read/write path 248 is reading servo data can be updated each time an additional servo zone is read. In this manner, the servo AGC value(s) determined for a most recently read servo zone can be the starting servo AGC value(s) when the next servo zone is read.

The read/write path 248 includes the electronic circuits used in the process of writing and reading information to and from the magnetic disks 212. The MPU can perform servo control algorithms, and thus, may be referred to as a servo controller. Alternatively, a separate microprocessor or digital signal processor (not shown) can perform servo control functions.

Although a particular block diagram of a disk drive 200 is shown and described as an example the invention is not so limited. One of ordinary skill in the art, having the benefit of the present disclosure will recognize that other configurations of circuit components, arrangements, etc. are within the scope of the invention. Further, as noted above, a hard disk drive is described only as an example of a storage device. Methods of encryption and data access described as follows can be used with other storage devices. Examples of other storage devices include optical storage, solid state storage, other magnetic media storage, or a combination such as a flash memory/hard disk drive.

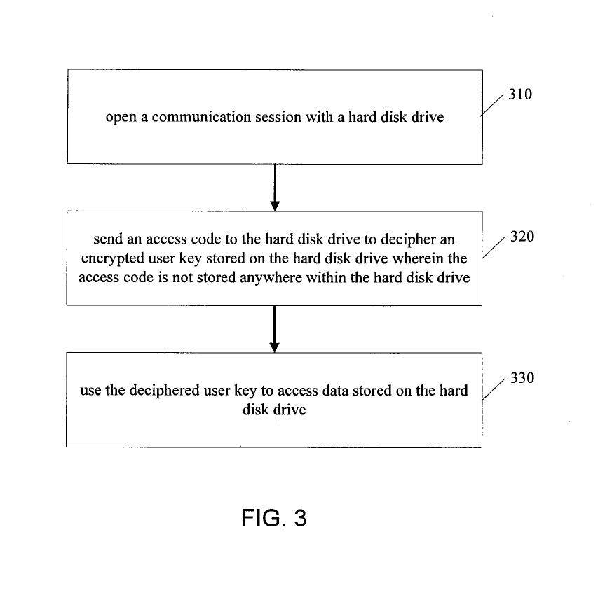

FIG. 3 illustrates an example method of providing secure access to data on a hard disk drive according to an embodiment of the invention. In operation 310, a communication session is opened between a host and a hard disk drive. A common example of a host includes a personal computer, such as a desktop computer, laptop computer, server, etc. Although a traditional computer is a common example of a host, the invention is not so limited. Other host form factors such as an MP3 music player, telephone, personal data assistant, etc. are possible.

In operation 320, an access code is sent to the hard disk drive to decipher an encrypted user key stored on the hard disk drive. In operation 320, the access code is not stored anywhere within the hard disk drive, and must be provided from the host. Because technology and methods exist that can retrieve an access code stored somewhere within a hard disk drive, the data on the drive is safer if the access code is not stored anywhere within the drive. In this way, even if the drive is stolen and tampered with, or installed into a different computer, the access code is not available, and the data remains secure.

A host computer, using the example of a laptop or desktop unit, has standard and secure ways of storing secrets (e.g., a trusted platform module (TPM)). In addition, the host computer has sufficient computation power to connect a secret from multiple sources (e.g., SMART cards, biometrics, passwords, etc.) and have that non-trivial secret be the “access code” used to decipher the user key stored on the hard drive. In one embodiment, the access code includes portions from one or more sources as described above (SMART cards, biometrics, passwords, etc.).

In operation 330, using the proper access code provided from the proper host, the encrypted user key that is stored on the hard disk drive is deciphered. The user key is then used to access data stored on the hard disk drive.

In one example, the data is encrypted, so that it cannot be read without the appropriate key. In one example the media is encrypted with a separate media key, and the media key is accessible only through use of the user key. Although only a single user key is discussed for ease of explanation, it will be appreciated that a number of user keys encrypted as described above are possible on a single hard disk drive.

In one example, a number of partitions are included on the hard disk drive. In selected partition examples, a partition key is also included on the hard disk drive to access each partition. In one partition key example, the user key is deciphered using an access code provided by a host as described above. The user key is then able to access one or more partition keys associated with the user key. In one example a media key is further accessed using the partition key to access encrypted data in each partition.

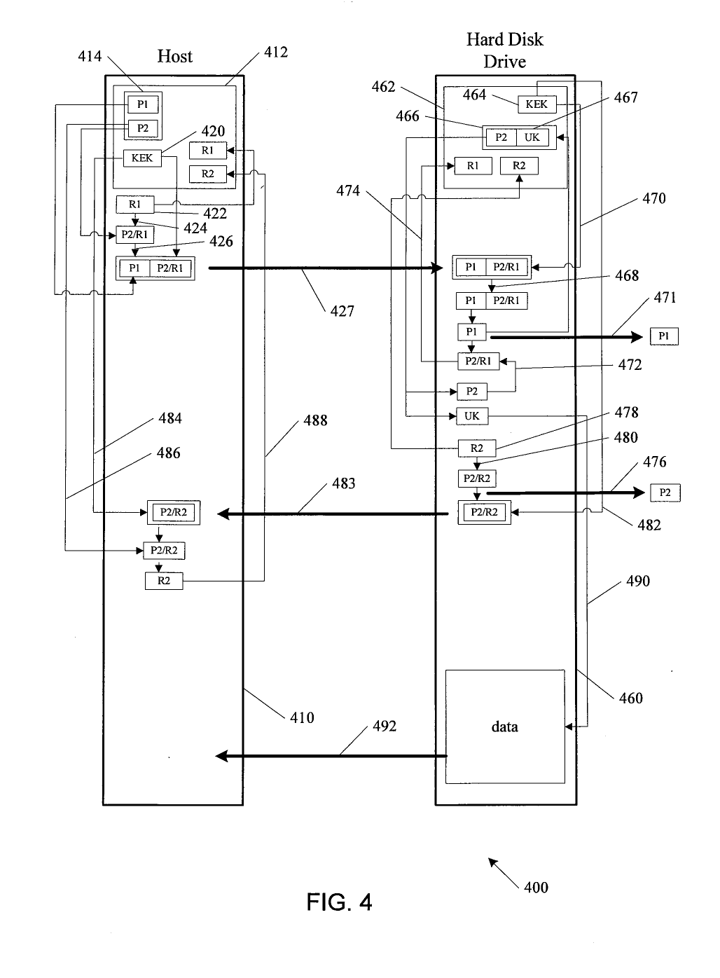

FIG. 4 illustrates a more detailed example of information exchange between a host 410 and a hard disk drive 460. In the example, the host 410 includes local memory 412. Examples of memory 412 located at the host 410 include flash or other non-volatile memory, portions of which may reside within a trusted platform module (TPM). The memory 412 can be integrated into a processor chip, located separately in a chip set, or located elsewhere within the host 410.

Likewise the hard disk drive 460 includes local memory 462. The memory 462 includes possible locations on the hard disk itself, or non-volatile memory in another portion of the hard disk drive, such as in a flash chip, etc.

FIG. 4 illustrates an access code 414 located within the host memory 412. In the embodiment shown, the access code 414 includes a two part unique identification number. A first part P1 and a second part P2 of the two part unique identification number, or access code 414 are shown. Although effective advantages exist for using a two part access code 414 are described below, the invention is not so limited. Embodiments using a single access code stored within a host memory 412 are within the scope of the invention. Although the term “number” is used to describe the two part unique identification number, one of ordinary skill in the art, having the benefit of the present disclosure will recognize that alpha-numeric combinations, or other access code combinations aside from numerals are within the scope of the invention.

A key encryption key 420 is also shown located both in the host memory 412 and the hard drive memory 462. An example of a key encryption key includes an AES key wrap protocol, although the invention is not so limited.

In a first operation 422 as shown in FIG. 4, a first session key component R1 is generated at the host 410. A copy of the first session key component R1 is stored in the host memory 412 in preparation for a secure data exchange. In one embodiment, the first session key component R1 is a random number. In a second operation 424, the first session key component R1 is mixed with the second part P2 of the access code 414. One example of mixing includes combining the two (R1 and P2) using an XOR operation. The XOR operation ensures that the component R1 can only be unmixed or otherwise obtained if in possession of P2.

In operation 426, P1 is obtained from host memory 414 and concatenated, or otherwise packaged along with the package (P2 XOR R1), and the group {P1,(P2 XOR R1)} is key wrapped using the key encryption key 420. The key wrapped group {P1,(P2 XOR R1)}_{KEK} is then passed to the hard disk drive 460 in operation 427.

In this way, the access code 414, all or part of which is not stored within the hard disk drive 460, is passed to the hard disk drive to begin a process of obtaining a user key 467. Although in the embodiment shown, a portion of the access code (P2) is contained within the hard disk drive memory 462, the second portion P2 is encrypted using the first portion P1. Therefore P2 will only be accessible when P1 is obtained from a host outside the hard disk drive 460.

The hard disk drive 460 also possesses a copy 464 of the key encryption key 420, therefore the hard disk drive 460 is able to unwrap the group {P1,(P2 XOR R1)}. P1 and (P2 XOR R1) are now available to the hard disk drive 460. In operation 470,P1 is used to decipher the P1 encrypted group 466 also denoted as {P2, UK}_{P1}. After the group 466 is deciphered, both P2 and UK are available for use in the hard disk drive 460. In one embodiment, the first part P1 of the access code 414 is then thrown away from the hard disk drive 460 in operation 471. This procedure ensures that P1 will not be stored anywhere within the hard disk drive 460 where it could possibly be discovered and used for subsequent unauthorized access.

In operation 472, the group (P2 XOR R1) is unmixed using P2. In operation 474, the value R1 is then stored in the hard disk drive memory 462 in preparation for a secure data exchange. At this stage in the operation, the hard disk drive 460 has a copy of the first session key component R1 that was generated at the host 410. The hard disk drive 460 also has an unencrypted version of the user key 467.

In operation 478, the hard disk drive 460 generates a second session key component R2. A copy of the second session key component R2 is stored in the drive memory 462 in preparation for a secure data exchange. Similar to the first session key component R1, in one embodiment, the second session key component R2 is a random number. Similar to the operation in the host 410, in operation 480, the second session key component R2 is mixed with the second part P2 of the access code 414. One example of mixing includes combining the two (R2 and P2) using an XOR operation. The XOR operation ensures that the component R1 can only be unmixed or otherwise obtained if in possession of P2. Similar to the procedure with P1, in one embodiment the second part P2 of the access code 414 is then thrown away from the hard disk drive 460 in operation 476.

In operation 482, the group (P2 XOR R2) is key wrapped using the copy of the key encryption key 464. In one example, the key encryption key is the same for both the host and the hard disk drive. Other embodiments include key encryption keys that are different depending on the direction of traffic. The key wrapped group {(P2 XOR R)}KEK is then passed to the host 410 in operation 483. The host then uses its copy of the key encryption key 420 in operation 484 to unwrap the group (P2 XOR R2)_{KEK}. The host further uses its copy of the second part P2 of the access code 414 in operation 486 to unmix the group (P2 XOR R2) and obtain the second session key component R2. In operation 488, the value R2 is stored in the host memory 412 in preparation for a secure data exchange.

At this point in the operation, both the host 410 and the hard disk drive 460 have both session key components R1 and R2 stored in memory. The hard disk drive 460 also has an unencrypted copy of the user key 467. The hard disk drive 460 is now able to access data as shown in operation 490, using the user key 467, and to securely communicate the data to the host as shown in operation 492.

As discussed above, other layers of security below the user key level are also possible. For example partition keys, and media keys may also be employed to selectively encrypt an protect data.

Although one example method of providing secure data access in a hard disk drive is shown in FIG. 4, the invention is not so limited. One of ordinary skill in the art will recognize that other variations of the method and variations of access codes are within the scope of the invention.

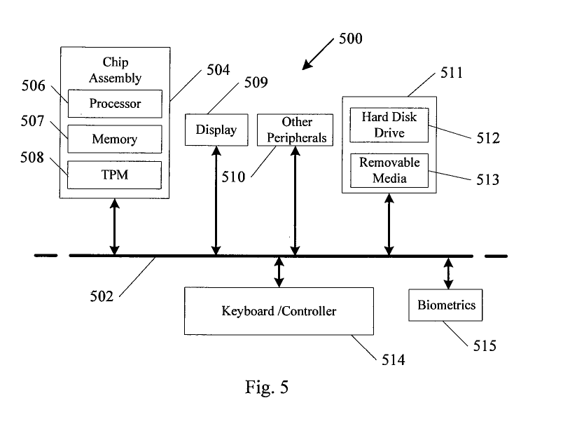

An embodiment of an information handling system such as a computer is included in subsequent figures to show an embodiment of a high-level device application for the present invention. FIG. 5 is a block diagram of an information handling system 500 incorporating hardware and machine readable instructions to provide secure access to data according to an embodiment of the invention. Information handling system 500 is merely one embodiment of an electronic system such as a personal computer in which the present invention can be used. Other examples include, but are not limited to, MP3 players, digital video recorders, aircraft, other vehicles, etc.

In this example, information handling system 500 comprises a data processing system that includes a system bus 502 to couple the various components of the system. System bus 502 provides communications links among the various components of the information handling system 500 and may be implemented as a single bus, as a combination of busses, or in any other suitable manner.

Chip assembly 504 is coupled to the system bus 502. Chip assembly 504 may include any circuit or operably compatible combination of circuits. In one embodiment, chip assembly 504 includes a processor 506 that can be of any type. As used herein, “processor” means any type of computational circuit such as, but not limited to, a microprocessor, a microcontroller, a graphics processor, a digital signal processor (DSP), or any other type of processor or processing circuit.

In one embodiment, a memory chip 507 is included in the chip assembly 504. Those skilled in the art will recognize that a wide variety of memory device configurations may be used in the chip assembly 504. Acceptable types of memory chips include, but are not limited to, Dynamic Random Access Memory (DRAMs), flash memory, or other non-volatile memory.

In one embodiment, a trusted platform module 508 is further included on the chip assembly 504. One example of TPM 508 provides for the secure generation of cryptographic keys, and limitation of their use, in addition to a hardware random or pseudo random number generator. Although the TPM 508 is shown as part of the chip assembly 504, other embodiments locate the TPM elsewhere as a peripheral on a bus such as the example bus 502 shown.

In one embodiment, a biometrics device 515 is included as a peripheral device, or otherwise incorporated into the information handling system 500. An example of a biometrics device 515 includes a fingerprint reader. In one example information from the biometrics device 515 is used at least in part as an access code as described in embodiments above.

Information handling system 500 may also include an external memory 511, which in turn can include one or more memory elements suitable to the particular application, such as one or more hard drives 512, and/or one or more drives that handle removable media 513 such as floppy diskettes, compact disks (CDs), digital video disks (DVDs), removable or fixed flash memory and the like. A hard disk drive 512 as described in examples above is included in the information handling system 500.

Information handling system 500 may also include a display device 509 such as a monitor, additional peripheral components 510, such as speakers, etc. and a keyboard and/or controller 514, which can include a mouse, trackball, game controller, voice-recognition device, or any other device that permits a system user to input information into and receive information from the information handling system 500.

The foregoing description of the specific example embodiments reveals the general nature of the invention sufficiently that others can, by applying current knowledge, readily modify and/or adapt it for various applications without departing from the generic concept, and therefore such adaptations and modifications are intended to be comprehended within the meaning and range of equivalents of the disclosed example embodiments.

The Abstract is provided to comply with 37 C.F.R. §1.72(b) to allow the reader to quickly ascertain the nature and gist of the technical disclosure. The Abstract is submitted with the understanding that it will not be used to interpret or limit the scope or meaning of the claims.

It is to be understood that the phraseology or terminology employed herein is for the purpose of description and not of limitation. Accordingly, the invention is intended to embrace all such alternatives, modifications, equivalents and variations as fall within the spirit and broad scope of the appended claims.

What is claimed is:

1. A method comprising:
opening a communication session with a storage drive;
sending an access code to the hard disk drive to decipher an encrypted user key stored on the storage drive;
wherein the access code is not stored anywhere within the storage drive; and
using the deciphered user key to access data stored on the storage drive.

2. The method of claim 1, wherein sending the access code includes sending two separate parts of a unique identification number.

3. The method of claim 1, wherein sending an access code includes sending the access code key wrapped.

4. The method of claim 1, wherein using the deciphered user key to access data includes using the deciphered user key to decipher one or more encrypted partition keys, and further using the partition keys to access the data.

5. The method of claim 4, wherein using the partition keys to access the data includes using the partition keys to decipher one or more encrypted media keys, and further using the media keys to access the data.

6. The method of claim 1, wherein sending the access code to the storage drive to decipher the encrypted user key stored on the storage drive includes sending an access code to the storage drive, and throwing away the access code after the user key is deciphered.

7. A method comprising:
generating a first session key component at a host and storing the first session key component in a host memory;
sending the first session key component and an access code from the host to a hard drive;
storing the first session key component on the hard drive;
deciphering an encrypted user key stored on the hard drive using the access code;
generating a second session key component and storing the second session key component on the hard drive;
sending the second session key component from the hard drive to the host;
storing the second session key component in the host memory; and
using the first and second session key components stored in the host memory and the first and second session key components stored in the hard drive to encrypt communication between the host and the hard drive.

8. The method of claim 7, wherein sending the first session key component and an access code includes sending the first session key component and a two part access code, including a first access code part and a second access code part.

9. The method of claim 8, wherein sending the first session key component and the two part access code includes sending the first session key component and the two part access code key wrapped.

10. The method of claim 8, wherein sending the first session key component and an access code includes:
mixing the first session key component with the second access code part; and
sending the first access code part along with the mixed first session key component.

11. The method of claim 10, wherein mixing the first session key component with the second access code part includes XOR mixing the first session key component with the second access code part.

12. The method of claim 10, wherein deciphering an encrypted user key stored on the hard drive includes using the first access code part to decipher the user key and a copy of the second access code part, both of which are encrypted together on the hard drive.

13. The method of claim 12, further including deciphering the first session key component using the copy of the second access code part.

14. The method of claim 13, wherein sending the second session key component from the hard drive to the host includes sending a second session key component mixed with the second access code part.

15. The method of claim 14, wherein sending the second session key component mixed with the second access code part includes sending a second session key component XOR mixed with the second access code part.

16. The method of claim 14, further including deciphering the second session key component at the host using a host copy of the second access code part.

17. A hard disk drive, comprising:
encrypted data stored on a disk;
an encrypted user key, the user key operable to decipher the encrypted data, wherein an access code to the encrypted user key is not stored within the hard disk drive; and
instructions stored in a media within the hard drive to accept the access code when supplied from an external host and to decipher the user key.

18. The hard disk drive of claim 17, further including a number of partitions with partition keys that are encrypted using the user key.

19. The hard disk drive of claim 17, wherein the encrypted user key is encrypted with a part of a two part unique identification number.

20. The hard disk drive of claim 17, further including a key encryption key stored within the hard disk drive to decipher the access code when provided from an external host.
